(19) United States
(12) Patent Application Publication
(10) Pub. No.: US 2006/0028917 A1
(43) Pub. Date: Feb. 9, 2006

(54) Milestone bar calender

(75) Inventor: Virginia Ann Wigginton, Round Rock, TX (US)

Correspondence Address: Mark D. Simpson;Synnestvedt & Lechner LLP, 2600 Aramark Tower, 1101 Market Street, Philadelphia, PA, 19107-2950, US

(73) Assignee: International Business Machines Corp., Armonk, NY (US)

(21) Appl. No.: 10/912,502

(22) Filed: Aug. 5, 2004

(51) Int. Cl. G04B 19/24

(52) U.S. Cl. 368/28

(57) ABSTRACT

A “milestone bar calendar” is displayed on a user's display screen of a computer, PDA, cell phone, etc. In a typical arrangement, the bar calendar will be displayed horizontally across the top of the screen, integrated with toolbars that are typically found on most graphical user interfaces. In a preferred embodiment, twelve months, starting with the current month, will be displayed in the milestone bar calendar, and markers for upcoming milestones/events will be displayed within the bar, associated with the appropriate month. Designating a marker with a pointing device provides details regarding the milestone/event.

### BACKGROUND OF THE INVENTION

1. Field of the Invention

The present invention relates to event tracking and, more particularly, to the electronic display of multiple events over a predetermined time period.

2. Description of the Related Art

Electronic calendars are well known and form an everyday business tool and personal time management tool for many users of PCs, PDAs, cell phones and the like. Using electronic calendars, a user may input appointments days, weeks, months, and even years in advance and, when the appointment dates approach, the user can be reminded, either visually or through the use of alarms. Many people have abandoned altogether the use of paper calendars and paper daily planners in favor of these electronic calendaring systems.

Most electronic calendars give the user a choice of displays, typically daily, weekly, monthly, and, in some instances, annually. These views typically take up the entire screen, although sometimes they may be displayed in smaller sub-elements on the screen so that the computer screen or other display device can be used for other tools while leaving the calendar viewable. To be able to view long-term commitments and appointments, one must view the calendar in a “twelve month view“, which shows the entire calendar year, from January to December, on a single page. This has the problem that it takes up the entire viewing screen (if it was attempted to show the entire twelve-month view in only a portion of the screen, it would be too small to be of any value), and does not show anything except for the present year. That is, a 2004 calendar will display January to December 2004, even if the current date is Jul. 1, 2004.

Most users typically view the calendar on a daily, weekly, or monthly basis, and have to perform manual manipulation to look beyond the next time increment (day, week, month, year). Accordingly, appointments and commitments coming due in the next time increment are not typically visible to the user, and thus, events set for the beginning of the next time increment may surprise the user. This is of particular concern on an annual basis, where the twelve-month view, on December 29, will show January-December, 2004, and will only show commitments for the year 2004 and will not display any events occurring on, for example, Jan. 2, 2005.

Therefore, it would desirable to have a method, system, and computer program product whereby a user will always be alerted as to appointments, commitments, etc. from the current date and into the future by a simple and easy mechanism visible on the screen at all times.

### SUMMARY OF THE INVENTION

The present invention is referred to as a “milestone bar calendar” which is always displayed on a user's screen if set to do so. In a typical embodiment, the bar will be displayed horizontally across the top of the screen, integrated with toolbars that are typically found on most graphical user interfaces. In the preferred embodiment, twelve months, starting with the current month, will be displayed in the milestone bar calendar, and markers for upcoming milestones/events will be displayed within the bar, associated with the appropriate month.

### BRIEF DESCRIPTION OF THE DRAWINGS

FIG. 1 is a simulated screen capture showing the present invention displayed along the top of the screen;

FIGS. 2-5 illustrate the milestone bar calendar of the present invention; and

FIG. 6 illustrates the changing of the current date to a new month in accordance with the present invention.

### DETAILED DESCRIPTION OF THE PREFERRED EMBODIMENTS

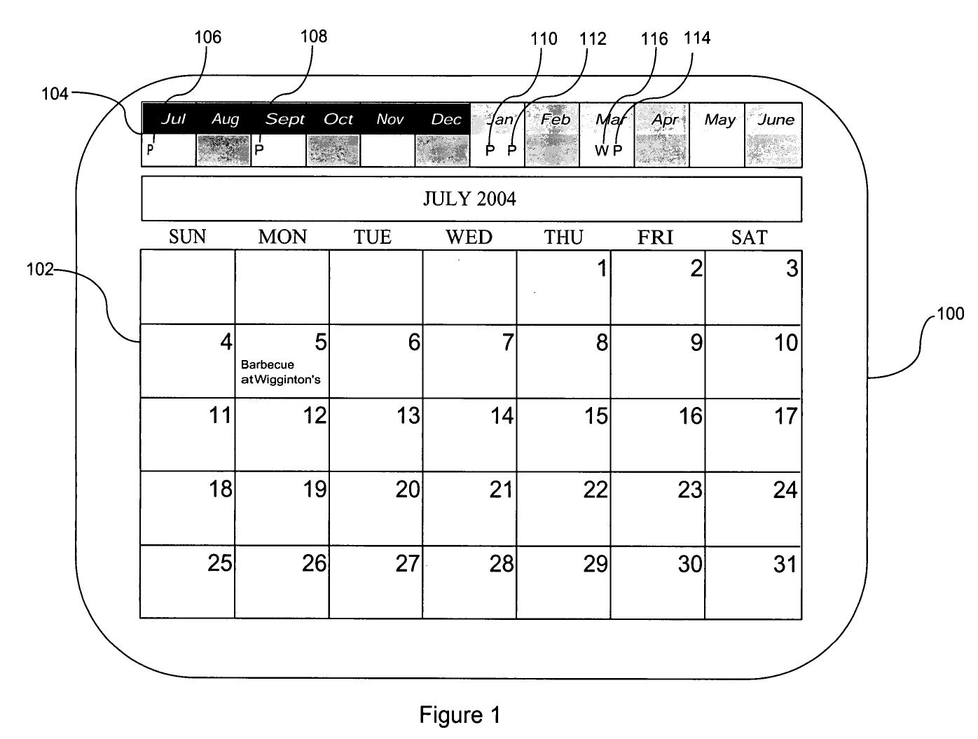

FIG. 1 is a simulated screen capture of a calendaring page for the month of July, 2004, with the present invention displayed along the top of the screen. More specifically, a viewing area 100 of a computer monitor (or other display device such as a PDA, cell phone, etc.) displays a typical month-view calendar 102 for the month of July, 2004. Situated along the top of the screen, above the calendar 102, is a milestone bar calendar 104 in accordance with the present invention. As can be seen from FIG. 1, the milestone bar calendar 104 illustrates, in this example, twelve months in the future, beginning with the current month, in this example, July. A grid of twelve boxes, one for each displayed month, is situated beneath the month names, so that each month has a corresponding grid box associated therewith.

The grid boxes provide an easily viewable area in which to place milestone markers associated with events occurring in the month associated with a grid box. For example, milestone bar calendar 104 of FIG. 1 has milestone markers 106 associated with July; 108 associated with September; 110 and 112 associated with January 2005; and milestone markers 114 and 116 associated with March 2005. In this example, two different types of milestone markers are displayed. Markers 106-114 appear as the letter “P” and, in this example, are used to designate personal milestones, while marker 116, in the form of the letter “W”, is used to designate a work-related or professional milestone. Obviously numerous other letters, shapes, colors, etc. can be used to designate as many different types of milestones as are desired. Numerous other variations will be apparent to designers of a specific milestone bar calendar and such variations are considered part of the present invention.

As can be seen from the milestone bar calendar 104 of FIG. 1, at minimum, the display of the milestone markers alerts a user as to events, appointments, etc. occurring into the future, and allows the user to look beyond the end of the calendar year to avoid a “January surprise” for example. This aspect of the invention, in and of itself, provides significant benefit to the user of the invention.

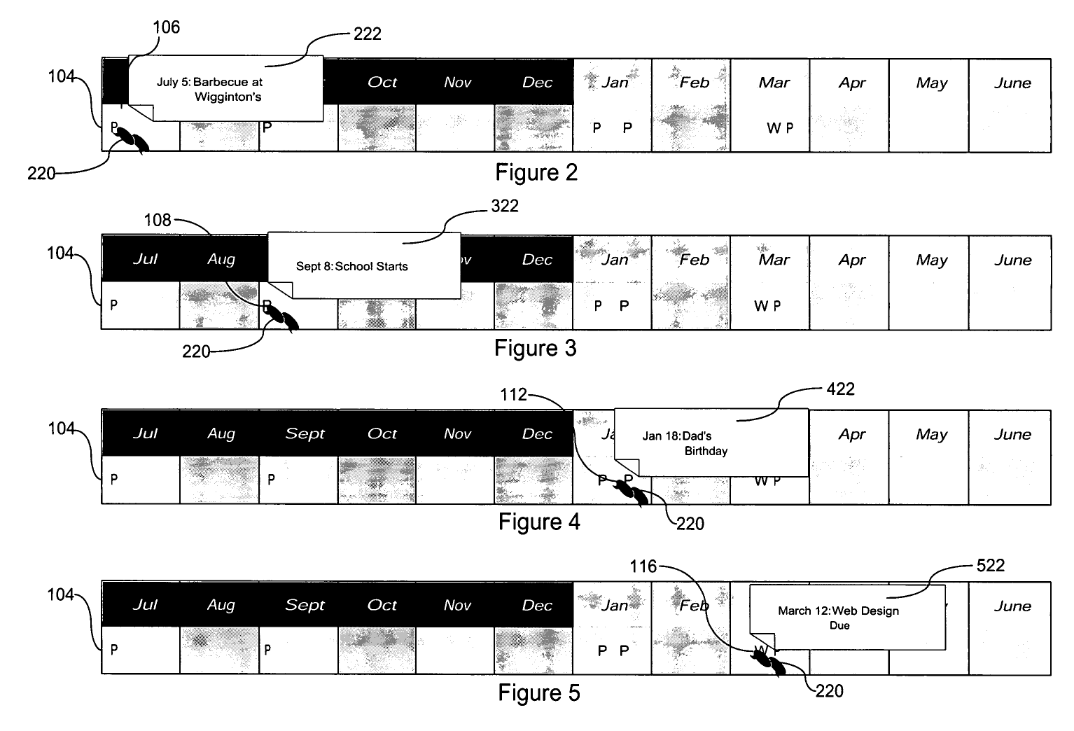

A preferred embodiment of the present invention is illustrated in connection with FIGS. 2-5. FIGS. 2-5 illustrate the milestone bar calendar 104 of FIG. 1 separately from any display in a display area. Referring first to FIG. 2, if a user hovers a mouse pointer 220 over milestone marker 106, a text box 222 appears, in a well known manner, to provide some level of detail regarding milestone marker 106. In this example, milestone marker 106 corresponds to the July 5 entry “Barbecue at Wigginton's” which can be seen in calendar 102 of FIG. 1. Referring to FIG. 3, hovering mouse pointer 220 over milestone marker 108 displays a text box 322 indicating that on September 8, school starts. FIG. 4 and FIG. 5 illustrate additional, similar displays. In FIG. 4, hovering mouse pointer 220 over milestone marker 112 indicates that January 18 is “Dad's Birthday”, and referring to FIG. 5, hovering mouse pointer 220 over milestone marker 116 (in this example, a work-related milestone marker) indicates that on March 12, a Web Design is Due. These figures (FIG. 2-5) illustrate the ability of a user to look forward beyond the display on the screen or the calendar year to identify important milestones that will be coming up.

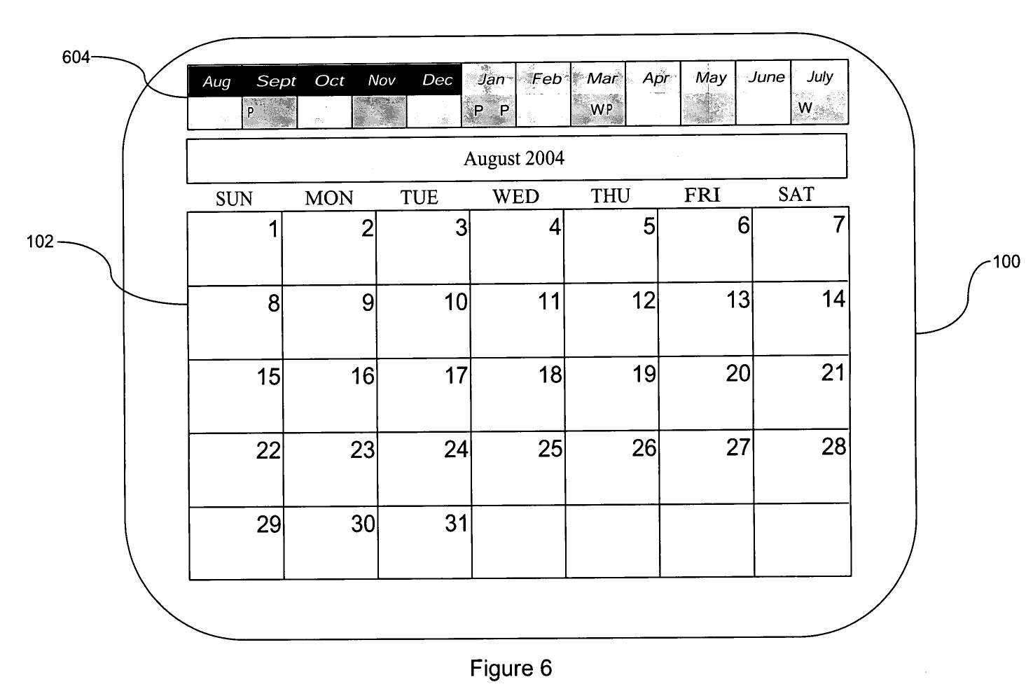

FIG. 6 illustrates how the changing of the current date to a new month will also change the display of the milestone bar calendar. Referring to FIG. 6, if it is assumed that the current date illustrated is Aug. 1, 2004, milestone bar marker 604 now shows the months August-December 2004 and January-July 2005, i.e., the current month now appears on the far left and a new month, July, 2005, is added to the far right side.

While the illustrations in FIGS. 1-6 show the milestone bar marker used in connection with a calendar 102, it is understood that any images, e.g., images from a web browser, a word processing program, or any other program or display utilized by a device configured to use the milestone bar calendar of the present invention can be displayed on the display screen 100 simultaneously with the display of the milestone bar calendar. Further, as mentioned above, although not illustrated in this manner, the milestone bar marker can be included to appear as part of the various taskbars, menu bars, etc. that appear at the top of most graphical user interfaces. For example, the milestone bar marker can be “connected” to the task bars in much the same manner that “hot bars” are frequently added to taskbar menus.

In addition, although headings are shown to identify the 12 months being displayed, it is understood that these headings are optional and that by using different colors/shading for alternate months, a user will still be able to differentiate from one month to the next, and can hover or click on a marker to identify exactly what month the milestone associated with the marker occurs. Even without the heading for the month, it will be clear that some event/milestone is coming up.

Other standard GUI options (e.g., right-clicking to change options, add events, etc.) are also optional and are considered as being included in the present disclosure. Further, although shown displayed horizontally, the milestone bar calendar can be displayed vertically or diagonally as well. In addition, although a full year is displayed in the drawing figures, it is understood that the present invention can be used to display any desired time increments (minutes, hours, days, weeks, months, years, etc.).

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of a workstation or other device on which the milestone bar calendar of the present invention is utilized. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

We claim:

1. An electronic milestone calendar, comprising:
a display area segmented into plural time increments;
wherein said electronic milestone calendar continuously displays a fixed number of present and future time increments beginning with a present time increment.

2. The electronic milestone calendar of claim 1, wherein each of said time increments comprises one month, and wherein said fixed number of present and future time increments comprises twelve time increments.

3. The electronic milestone calendar of claim 2, wherein said each of said displayed time increments is adjacent to at least one other displayed time increment, and wherein each displayed time increment is visibly discernable from any adjacent displayed time increment.

4. The electronic milestone calendar of claim 3, wherein each displayed time increment is visibly discernable from any adjacent displayed time increment by varying the color of adjacent displayed time increments.

5. The electronic milestone calendar of claim 3, wherein each displayed time increment is visibly discernable from any adjacent displayed time increment by associating a name with each displayed time increment, whereby each displayed time increment has a name that is different from any displayed time increments adjacent thereto.

6. The electronic milestone calendar of claim 1, wherein each displayed time increment includes a milestone display area in which are displayable milestone markers representing events occurring within the time increment in which the milestone markers are displayed.

7. The electronic milestone calendar of claim 6, wherein designating any of said displayable milestone markers with a pointing device causes the display of detailed information pertaining to events represented by said designated displayable milestone marker.

8. The electronic milestone calendar of claim 1, wherein said display area is integrated into a toolbar of a graphical user interface.

9. A method of displaying an electronic calendar on a display device, said electronic calendar having a display area, comprising:
segmenting said display area into plural time increments; and
continuously displaying a fixed number of present and future time increments on said display beginning with a present time increment.

10. The method of claim 9, wherein each of said time increments comprises one month, and wherein said fixed number of present and future time increments comprises twelve time increments.

11. The method of claim 10, further comprising:
displaying each of said time increments adjacent to at least one other displayed time increment; and
configuring each displayed time increment so that it is visibly discernible from any adjacent displayed time increment.

12. A system of displaying an electronic calendar on a display device, said electronic calendar having a display area, comprising:
means for segmenting said display area into plural time increments; and
means for continuously displaying a fixed number of present and future time increments on said display beginning with a present time increment.

13. The system of claim 12, wherein each of said time increments comprises one month, and wherein said fixed number of present and future time increments comprises twelve time increments.

14. The system of claim 13, further comprising:
means for displaying each of said time increments adjacent to at least one other displayed time increment; and
means for configuring each displayed time increment so that it is visibly discernible from any adjacent displayed time increment.

15. A computer program product for displaying an electronic calendar on a display device, said electronic calendar having a display area, the computer program product comprising a computer-readable storage medium having computer-readable program code embodied in the medium, the computer-readable program code comprising:
computer-readable program code that segments said display area into plural time increments; and
computer-readable program code that continuously displays a fixed number of present and future time increments on said display beginning with a present time increment.

16. The computer program product of claim 15, wherein each of said time increments comprises one month, and wherein said fixed number of present and future time increments comprises twelve time increments.

17. The computer program product of claim 10, further comprising:
computer-readable program code that displays each of said time increments adjacent to at least one other displayed time increment; and
computer-readable program code that configures each displayed time increment so that it is visibly discernible from any adjacent displayed time increment.
